(19) United States
(12) Patent Application Publication
(10) Pub. No.: US 2025/0105770 A1
(43) Pub. Date: Mar. 27, 2025

(54) DEVICE AND METHOD FOR CONTROLLING A SYNCHRONOUS MACHINE AND FOR ESTIMATING ROTOR POSITION, FROM START-UP TO A PREDETERMINED LOW SPEED

(71) Applicant: SAFRAN ELECTRICAL & POWER, BLAGNAC (FR)

(72) Inventor: Najib ROUHANA, MOISSY CRAMAYEL (FR)

(21) Appl. No.: 18/729,109

(22) PCT Filed: Dec. 23, 2022
(86) PCT No.: PCT/FR2022/052501

§ 371 Date: Jul. 15, 2024

(30) Foreign Application Priority Data
Jan. 17, 2022 (FR) FR2200377

(51) Int. Cl. H02P 21/28; H02K 11/33; H02P 21/18; H02P 21/22; H02P 21/34

(52) U.S. Cl. CPC H02P 21/28; H02K 11/33; H02P 21/18; H02P 21/22; H02P 21/34; H02P 2207/05

(57) ABSTRACT

One aspect of the invention relates to a control device (2) for starting up a synchronous electric motor (1) up to a predetermined threshold speed, comprising: a current regulator (4) that delivers a voltage setpoint (V #dq) in accordance with a regulation current setpoint (l #dq′), a computing unit (5) for computing a current feedback. (Idq) in accordance with measurements of the phase currents (lu, Iv, Iw), an estimator (6) for estimating an angular position of the rotor (θelec), in accordance with a difference between a reference stator flux vector (λq) that depends on the feedback currents (Iq) and an adaptive stator flux vector (λqv) that depends on the voltage setpoint (V^{#}dq), on the feedback currents (Iq, Id), and on an estimated electrical speed (ωelec), a setpoint current modifier (7) that computes, when the estimated electrical speed (ωelec) is lower than the predetermined threshold speed, a regulator setpoint DC current (l^{#}d) having a non-zero value.

### TECHNICAL FIELD OF THE INVENTION

The technical field of the invention is that of the control of synchronous rotating electric machines devoid of an angular position sensor by estimating an angular position of a rotor relative to a stator.

The present invention relates to the method for controlling a synchronous motor devoid of an angular position sensor from start-up to low speed.

### TECHNOLOGICAL BACKGROUND OF THE INVENTION

An electric machine is equipped with a field stator comprising windings and a rotor comprising an armature body and a rotation shaft.

To control a synchronous electric machine, it is necessary to know the position and speed of the rotor. It is thus known to use a rotor angular measurement sensor (encoder or resolver) for detecting the exact position of the rotor as well as its rotation speed and to send this rotor position signal to a control unit. In a self-driven electric machine, this signal is used to lock currents in the field stator windings. This allows the inverter to adjust supply frequency depending on the rotor position, to maintain an angle θ of 90° between the stator rotating field Hs and a rotor field Hr, so that the motor torque can always be maximal.

However, in some high mass density applications, especially in aeronautics, it is increasingly difficult to integrate position sensors on the rotor shaft of the electric machine, in particular when the environment is of high overall size or difficult for maintenance. For example, such position sensors have to withstand high thermal stress, in particular, there is a need to use synchronous motors on aeroplanes that can go from a temperature of 45° C., for example on a tarmac, to a negative temperature of −70° C. when the aeroplane is at high altitude. Further, these position sensors are expensive and can be subject to other stresses, such as dust, humidity, etc. All these restrictions lead to a reduction in the MTBF (Mean Time Between Failure) of a repairable system.

Further, when the torque is very high, it may happen that the rotor shaft slip relative to the rotor body of the position sensor. An absolute position error arises between the reference axis of the position sensor and the magnetic axis of the electric machine. As a result, the initial angular setting of the angle sensor is altered. In addition, the moving part of the angle sensor can also slip on the rotor shaft, causing the angular position to shift. This shift causes degradation which can lead to a malfunction in the control of the electric machine. Indeed, in a synchronous machine, for example a three-phase permanent magnet machine, the torque produced depends on the interaction between the rotor flux and the stator flux in a so-called rotor plane, which is specific to the electric machine. As the rotor flux is produced by the permanent magnets, the torque is adjusted by adjusting the stator flux, for which two parameters are accessible: the flux amplitude, itself adjusted by the amplitude of the currents in the three-phase supply system, and the phase of the stator flux relative to the rotor flux. This phase is itself adjusted by the phase of the stator currents. For a non-salient pole synchronous machine at a given current amplitude, the maximum torque is obtained when the rotor flux is more or less in phase quadrature with respect to the stator flux.

There are thus control methods without a position sensor, thus making it possible to increase reliability and reduce cost of the control device.

There is especially a solution for estimating angular position of the motor using an approach based on estimating the counter-electromotive force between stator phases. However, the amplitude of the counter-electromotive force is proportional to the rotation speed of the electric machine. Thus, detectability of the electrical position naturally weakens with the reduction in the amplitude of the counter-electromotive forces as a function of the rotation speed of the electric machine. This solution is thus inapplicable at low rotation speeds as well as at standstill.

A control device is known which, for starting, uses an open loop starting sequence of the I/f (current/frequency) or V/f (voltage/frequency) type without using the information of the rotor position measured. Indeed, the electrical frequency of the stator field is imposed by the user and is gradually increased until it is high enough to be able to estimate electromotive forces. The slope of variation of the electrical frequency should be slow in order to ensure that the actual rotor flux of the electric machine is locked with the virtual rotor flux created by this open loop approach. It is only then that the regulation loop via the sensorless control algorithm can be used in a closed loop. This method requires perfect knowledge of the inertia and the load driven by the electric machine, thus as well as specific management of, on the one hand, speed acceleration to be introduced as a function of the torque and, on the other hand, transition between the open loop and the closed loop, otherwise the electric machine will lose synchronism.

In addition, a phenomenon which adds limitations of sensorless operation in the low rotation speed zone comes from semiconductors of the power converter which operate in a non-linear manner, due to the dead times applied to the rising edges of the PWM commands, the duration of the switching ON and OFF of the PWM commands as well as the voltage drop across the terminals of the semiconductors. All these phenomena together create a so-called voltage error, which is present on a microscopic scale, and whose impact is averaged on a macroscopic scale (at the level of a fundamental electrical cycle) and is dominant in the low rotation speed zone. Indeed, the error-fundamental amplitude ratio is high at low rotation speed, which is not the case at high rotation speed. The value of the frequency of the rank 1 voltage or current (h1) is called the “fundamental frequency”.

This voltage error distorts the fundamental frequency of the control voltage input to the electric machine (by introducing low-frequency harmonics). This is reflected identically in the stator currents, by means of the impedance of the electric machine which, at low rotation speed, is of low value and is unable to filter these low-frequency harmonics. Thus, as mentioned previously, the useful signal-to-noise ratio deteriorates, which has a negative impact on the method for estimating the rotor position at low rotation speed (since the same is designed on the assumption of the first fundamental frequency).

Thus one of the problems is to start a synchronous type electric motor in a closed loop and without a position sensor, from start-up with a torque up to a specific rotation speed.

### SUMMARY OF THE INVENTION

The invention offers a solution to the problems previously discussed, making it possible to ensure sensorless, closed loop start-up, thus preventing instability phenomena at low rotation speed and under maximum load torque, and to operate in wide defluxing zone of the electric machine. The invention makes it possible to provide a new solution based on a control algorithm without a position sensor, which makes it possible to ensure reliable and robust start-up in a closed loop, from standstill of the electric machine up to the maximum rotation speed.

One aspect of the invention relates to a device for controlling an inverter converter for starting a multiphase synchronous electric motor up to a predetermined threshold speed of an electric machine, the control device comprising:
a regulation loop, comprising:
   a current regulator for delivering a voltage setpoint comprising a quadratic and direct voltage with an angle, from a regulation current setpoint,
   a calculating unit for calculating a direct and indirect Park transformation, the calculating unit comprising a current return output in a Park reference frame, from measurement values of the phase currents received, transformed in a Park reference frame, into a return quadratic current and a return direct current, taking account of a value of estimated rotor angular position received,
   characterised in that the control device further includes:
a closed loop adaptive angle estimator, for estimating the value of the estimated rotor angular position, based on a difference between at least one piece of data of a reference stator flux vector calculated as a function of the return currents, and a piece of data of an adaptive stator flux vector, calculated from the voltage setpoint, the return currents, and an estimated electrical speed calculated as a function of this difference,
a setpoint current modifier, wherein, when an absolute value of the estimated electrical speed received by the adaptive angle estimator is less than the predetermined threshold speed, the modifier calculates a regulator setpoint direct current having a non-zero value, thereby modifying a setpoint direct current of a setpoint current received.

By virtue of the invention, the control device makes it possible to have an angular position estimation for a start-up up to at least one predetermined rotor rotation speed and then optionally beyond this predetermined rotation speed to shift to another calculation of the angular position, for example calculation of the angular position of the rotor by means of the electromotive force EMF.

Indeed, since the torque is normally equal to a gain multiplied by the quadratic current:

$${T}_{em} = {K}_{t} {i}_{q} \qquad [ Math 1 ]$$

with no angular position error, by injecting a direct current at start-up, if there is no position error, the torque at the rotor is equal to the estimated torque but if there is a position error, the torque at the rotor is different from the estimated torque, since the torque depends on the sine of the angular position error estimated:

$${T}_{em} \approx {\hat{T}}_{em} + {K}_{t} {\hat{i}}_{q} sin ( Δθ ) \qquad [ Math 2 ]$$

Therefore, as long as the sine of the angular position difference Δθ is not equal to 0, the actual torque Tₑₘ is not equal to the estimated torque \hat{T}ₑₘ because it is dependent on the direct current multiplied by the sine of the angular position difference Δθ.

Thus, by injecting a direct current I_{d} into the closed loop, the adaptive angle estimator will, by means of calculations, adapt the angular angle so that the same corresponds until the sine of the angular position difference Δθ is equal to 0.

In prior art, the angle estimator calculates the angular position from the EMF, however as the amplitude of the electromotive force is directly related to the rotation speed of the electric machine, detectability of the electrical position weakens with the reduction in the amplitude of the electromotive forces as a function of the rotation speed of the electric machine. At zero rotation speed (at standstill), the electromotive force is zero (undetectable) and the EMF of the electric machine is therefore unobservable. In other words, EMF-based methods are not useful from standstill tp a speed where the ratio of the electromotive force fundamental frequency to the measurement noise is high enough to identify the angular position.

The rotor flux remains constant and is non-zero and influences the stator flux according to its rotation. Thus, the invention makes it possible to estimate the rotor position based on the stator flux expressed in the rotor reference frame. The invention provides an approach for estimating the rotor position of the permanent magnet synchronous machine, based on a non-linear stator flux observer and which is adaptive as a function of the course of the rotation speed. At low speed and at standstill, the estimation is increased by injecting a non-zero current on the direct axis in the Park reference frame.

The invention thus has a logic for managing start-up of the electric machine which is carried out by injecting a non-zero value of the direct component of the current vector into the rotor space of the electric machine. This management logic thus makes it possible to add a current setpoint on the direct axis of the current, noted i_{d} as different from zero (non-zero), enabling the angle estimator to calculate the angular position from the stator flux and not from the EMF as in prior art and to obtain the angular position by removing an angular position error between the actual rotor plane of the electric machine and the virtual rotor plane of the command.

Another component of the control algorithm provided in this invention consists of an adaptive angle estimator whose role is to cancel an angular error between an actual reference frame of the machine and a virtual reference frame of the command. This angular error, ε, is simply the difference between a reference stator flux and an estimated stator flux. Indeed, the angle estimator calculates at least one piece of data of the reference stator flux vector from the stator currents measured. The estimated stator flux is calculated by the angle estimator in an adaptive manner, which calculates at least one piece of data of stator flux vector as a function of the control voltages v_{dq}^{#}, the stator currents measured and as a function of a feedback action of the rotation speed estimated. The feedback action of the rotation speed estimated is deduced by an adaptive mechanism for removing the rotor position error.

In other words, a correct electrical rotation speed is obtained only if the estimated stator flux vector tends towards the reference stator flux vector.

By simply integrating the rotation speed information, it is then possible to deduce the rotor position noted \hat{θ}_{elec}.

In addition, such a method operates in both directions of rotation of the electric machine, whether in the positive or negative trigonometric direction (clockwise), since a direct current I_{d} can be injected with a positive or negative sign depending on the direction of rotation of the rotor.

In addition to the characteristics just discussed in the preceding paragraph, the method according to one aspect of the invention may have one or several complementary characteristics from among those described in the following paragraphs, considered individually or according to any technically possible combinations.

According to one embodiment, the at least one piece of data of the reference stator flux vector is the quadratic value and the at least one piece of data of the quadratic stator flux vector is the quadratic value.

According to another embodiment, the closed loop adaptive angle estimator is configured to estimate the value of the estimated rotor angular position based on a difference between the reference stator flux vector (the direct or/and quadratic or/and angle data) calculated as a function of the return currents, and the adaptive stator flux vector (the direct or/and quadratic or/and angle data), calculated from the voltage setpoint, the return currents, and an estimated electrical speed calculated as a function of this difference.

According to one embodiment, the adaptive angle estimator comprises:
a first stator flux calculator comprising:
   a first block for calculating the reference stator quadratic flux,
   a second block for calculating the adaptive quadratic stator flux,
a second calculator for an estimated electrical speed as a function of a comparison of the adaptive quadratic stator flux and the reference quadratic stator flux,
a third calculator for estimating a value for the estimated rotor angular position as a function of the estimated electrical speed calculated.

According to one example of this embodiment, the first reference stator flux calculation block is modelled in a rotor reference frame.

According to one example of this embodiment, the second adaptive stator flux model calculation block is modelled in the rotor reference frame.

According to one example of this embodiment, the first calculation block calculates the reference quadratic flux according to the formula: LqIq wherein Lq is the quadratic value of the stator inductance on the axis q, Iq is the return quadratic current.

According to one example of this embodiment, the second calculation block calculates the adaptive quadratic stator flux according to the integral of the following formula:

$${v}_{q} - {R}_{s} {i}_{q} - {\hat{ω}}_{elec} {\hat{λ}}_{{d}_{v}} + k {\tilde{i}}_{q} \qquad [ Math 3 ]$$

wherein Rₛ is the stator resistance, \hat{λ}_{d}_{ᵥ} is the adaptive direct stator flux equal to the integral of the following formula:

$${v}_{d} - {R}_{s} {i}_{d} - {\hat{ω}}_{elec} {\hat{λ}}_{{q}_{v}} + k {\tilde{i}}_{d} \qquad [ Math 4 ]$$

and K is a positive gain matrix, v_{q} is the quadratic voltage of the setpoint voltage at the output of the current regulator, Iq (sometimes noted as Iq) is the return quadratic current, \hat{ω}_{elec} is the estimated electrical speed, \tilde{ι}_{d} and \tilde{ι}_{q} are the direct and quadratic components of the error in currents with

$${\tilde{i}}_{d} = {i}_{d} - {\hat{i}}_{d} \qquad [ Math 5 ]$$

$${\tilde{i}}_{q} = {i}_{q} - {\hat{i}}_{q}$$

and wherein the estimated direct current \hat{ι}_{d} and the estimated quadratic current \hat{ι}_{q} are calculated as a function of:

$${\hat{i}}_{d} = \frac{{\hat{λ}}_{{q}_{v}} - {φ}_{PM}}{{L}_{d}} \qquad [ Math 6 ]$$

$${\hat{i}}_{q} = \frac{{\hat{λ}}_{{q}_{v}}}{{L}_{q}}$$

According to one embodiment, the setpoint direct current modifier comprises an input for controlling a setpoint current.

In one embodiment, the modifier of the setpoint direct current calculates a regulator setpoint direct current equal to the square root of the sum of a value of the squared maximum quadratic current with the value of the setpoint quadratic current, received in the setpoint current:

$${I}_{d}^{\#} = \sqrt{Iq {max}^{2} - {\vert}^{\#} {q}^{2}} . \qquad [ Math 7 ]$$

According to one example of this embodiment, calculating the modified setpoint direct current is imposed with the same sign as the estimated electrical speed received.

According to one embodiment, the modifier of the setpoint direct current comprises a comparator for comparing the absolute value of the estimated electrical speed with the predetermined threshold speed.

According to one embodiment, the control device is able to control the converter for a rotation speed beyond the predetermined threshold speed, wherein if the absolute value of the estimated electrical speed is greater than the predetermined threshold speed, the setpoint direct current modifier transmits the regulation setpoint current according only to the setpoint current.

According to one example of this embodiment, when the absolute value of the estimated electrical speed is greater than the predetermined threshold speed, the modifier of the setpoint direct current transmits the setpoint current with a setpoint direct current equal to zero, unless a defluxing setpoint is sent.

According to one example of this embodiment, if the absolute value of the estimated electrical speed is greater than the predetermined threshold speed, the angular position estimator estimates the position and angular speed from an electromotive force EMF measured.

According to one embodiment, the calculation unit comprises a control output PWM able to be connected to the converter in order to control its electronic switches and in that the calculation unit is able to transform the Park inverse signal of the voltage setpoint received into a pulse width modulation signal.

According to one embodiment, the second calculator comprises a comparator comparing the reference stator quadratic flux with the adaptive quadratic flux and in that the estimated electrical speed calculated is transmitted to the first stator flux calculator, forming a closed loop.

According to one embodiment, the second calculator comprises a phase-locked loop (PLL) enabling, from the comparison value between the reference stator quadratic flux and the adaptive stator quadratic flux, to calculate an electrical speed value.

According to one embodiment, the third calculator calculates a rotor angle estimation by performing the integral of the estimated electrical speed. According to one example, the value of the estimated rotor angular position is an electrical angular position.

According to one embodiment, the control device further comprises a current measurement input per phase of the electric machine, for being connected to a current sensor measuring the current on the corresponding supply phase line.

According to one embodiment, the calculation unit comprises a voltage setpoint input received from the current regulator and is adapted to be connected to the inverter converter in order to transmit thereto a pulse width modulation command which makes it possible to drive the electronic power switches of the converter at a specific chopping frequency and thus to drive the fundamental frequency of the stator voltage input to the electric machine for driving the electric machine.

According to one embodiment, the adaptive angle estimator transmits the estimated electrical speed to the current regulator, especially in a PI current regulator block.

According to one embodiment, the control device comprises a processor and a memory, and in that the regulation loop, the adaptive angle estimator and the setpoint modifier are integrated into a program implemented by the processor from the memory.

Another aspect of the invention relates to a machine comprising:
a synchronous electric motor comprising a rotor, a stator,
a current measurement sensor,
an inverter converter comprising power switches and
the control device previously described with or without the various embodiments previously described, wherein the calculation unit transmits a command to the converter from the voltage setpoint to drive the electronic power switches at a specific chopping frequency and thus drive the fundamental frequency of the stator voltage input to the electric machine for driving the electric motor.

Another aspect of the invention relates to a method for driving a synchronous machine in a closed loop without a position sensor, from start-up to maximum rotation speed, comprising the steps of:
modifying a received current setpoint by imposing a non-zero modified setpoint direct current as long as an estimated speed is less than a predetermined threshold speed value, calculating a voltage setpoint comprising a quadratic and direct voltage with an angle, from a regulation current setpoint comprising a modified setpoint direct current,
calculating a command for driving electronic power switches of the inverter converter at a specific chopping frequency and thus driving the fundamental frequency of the stator voltage input to the electric machine, by an inverse Park transformation of the voltage setpoint and an estimated rotor angular position value,
measuring the phase currents and transforming them in a Park reference frame into a return quadratic current and a return direct current, taking account of the estimated rotor angular position,
calculating a reference stator quadratic flux as a function of the return quadratic current, the return direct current, the return current output and a calculated electrical frequency,
calculating adaptive quadratic stator flux, from the voltage setpoint, the return quadratic current, the return direct current, and the estimated electrical speed calculated,
calculating an electrical speed of the rotor from a comparison of the adaptive quadratic stator flux and the reference quadratic stator flux,
calculating the value of the estimated rotor angular position as a function of the electrical speed estimated calculated.

The invention and its different applications will be better understood on reading the following description and upon examining the accompanying figures.

### BRIEF DESCRIPTION OF THE FIGURES

The figures are set forth by way of indicating and in no way limiting purposes of the invention.

FIG. 1 shows a representation of a schematic diagram with functional blocks of an electric machine comprising a control device according to one embodiment of the invention.

FIG. 2 shows a schematic representation of an adaptive angle estimator of the control device according to one example of one embodiment of the invention.

FIG. 3 shows a schematic representation of a modifier of a setpoint direct current of a setpoint current of the control device according to one example of a first embodiment of the invention.

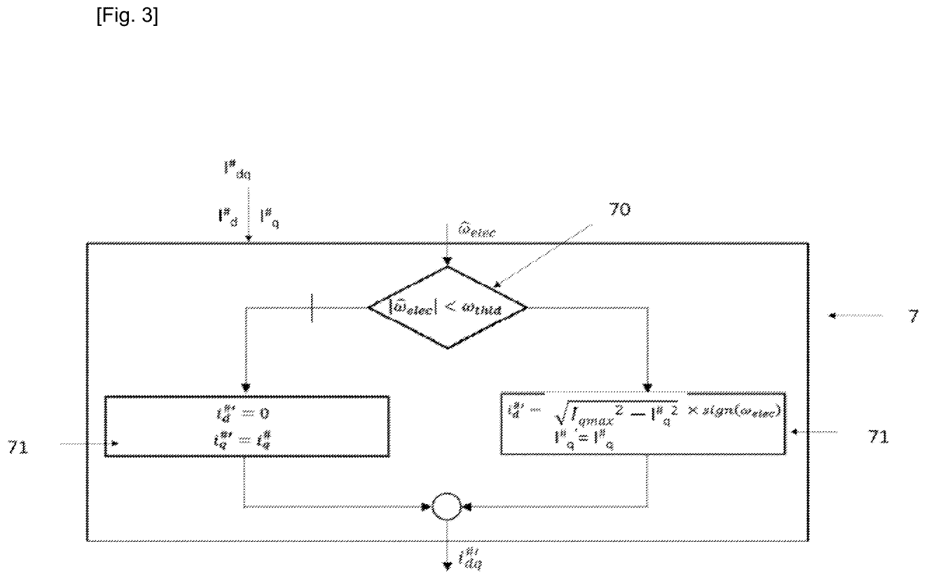

FIG. 4a shows a schematic representation of different graphs representing different measurements of a motor having a decreasing rotation speed.

FIG. 4b shows a schematic representation of a magnification of one of the graphs of FIG. 4a, representing the actual and estimated position measurement of a motor.

### DETAILED DESCRIPTION

The figures are set forth by way of indicating and in no way limiting purposes of the invention.

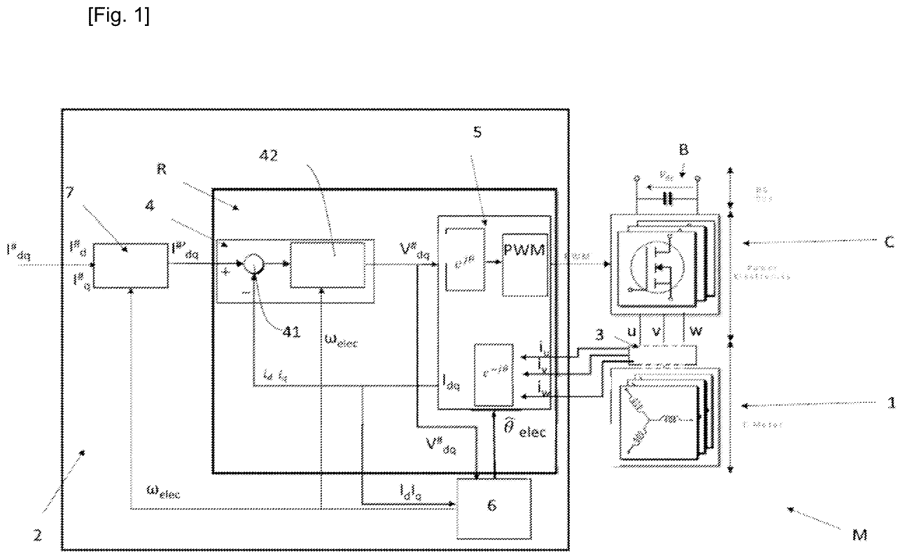

FIG. 1 represents a schematic diagram with functional blocks of an electric machine M comprising a synchronous electric motor 1, an inverter converter C supplying phases of the synchronous electric motor 1, a battery B and a control device according to one embodiment of the invention controlling the inverter converter C.

The electric machine M may be a machine of a turbomachine, wherein the electric motor 1 comprises a stator comprising X phases, a rotor surrounded by the stator. The electric motor 1 may operate in a motor mode and/or in a generator mode. The electric machine M is, for example, a multiphase synchronous electric machine of an aircraft propulsion unit. The rotor comprises a shaft and an active part mounted to the shaft. The active part of the rotor comprises magnets forming P pairs of poles. The number X in this example is three, but could be greater, for example five or six. The stator therefore comprises in this example three windings forming three phase outputs U, V, W of three phases which are represented in FIG. 1, as star-coupled but could for example be delta-coupled.

The inverter converter C is in this example of an inverter with a DC voltage input source either a DC/AC converter or a reversible inverter converter i.e. AC/DC and DC/AC converter in the case where the electric machine M also allows generator mode. The inverter converter C comprises N outputs, herein three outputs each connected to one of the corresponding phase outputs U, V, W. The inverter converter C further comprises power inputs, herein two DC voltage potentials connected to the terminals of a DC voltage bus B. The inverter converter C comprises electronic power switches and a control setpoint input, herein a pulse width modulation control which makes it possible to drive the electronic power switches at a specific chopping frequency and thus drive the fundamental frequency of the stator voltage input to the electric machine for driving the electric motor 1 of the electric machine.

The electric machine M further comprises a measurement means 3 for measuring phase currents Iu, Iv, Iw circulating on the phase outputs U, V, W. The measurement means 3 comprises, for example, a current sensor per phase for measuring the current in the corresponding phase.

The control device 2 comprises a regulation loop R schematically represented according to one example of a current regulator 4 comprising a current setpoint input of a regulation current setpoint I^{#}_{dq}′ comprising a modified setpoint direct current I^{#}_{d}′, explained in the following. The regulation current setpoint I^{#}_{dq}′ further comprises a quadratic current and an angle a.

The current regulator 4 comprises an output of voltage setpoint V^{#}_{dq} comprising a forward setpoint voltage and a quadratic setpoint voltage.

The regulation loop R further comprises a calculation unit 5 using a known mathematical method, namely the so-called “direct Park transform” to shift from a three-phase reference frame U; V; W linked to the stator to a two-phase rotating reference frame d; q, also knowing the angular position θ of the rotor of the electric motor 1 with respect to its stator, as well as the inverse Park transform to shift from the Park reference frame d; q to the three-phase reference frame U; V; W, also using an angular position of the rotor. The angular position θ of the rotor that is the position of the axis d in the reference frame dq, of the rotor with respect to the reference magnetic axis (which is the horizontal axis in (abc) which is fixed). The reference frame dq is rotational. Thus, between the two reference frames, there is an angle which varies from 0 to 360°. This is the position of the rotor in space.

The calculation unit 5 comprises a voltage setpoint input connected to the output of the regulator 4 for transforming the voltage setpoint V^{#}_{dq}′, with an inverse transformation and control calculator, and a control output connected to the control input of the inverter converter C, to transmit a PWM command calculated by the direct transformation calculator, herein in pulse width modulation. The inverse Park transformation and control calculator is therefore configured to transform vectors of the direct and quadratic setpoint voltages in a Park plane from an estimated position value of the rotor angular (\hat{θ}_{elec}) explained below, into a pulse width modulation PWM command. The pulse width modulation PWM command comprises electrical voltage signals, to control each phase in pulse width modulation and thus generate a balanced three-phase AC voltage system.

The calculation unit 5 further comprises measured current inputs receiving the phase currents iᵤ, iᵥ, i_{w} measured, the current inputs measured are connected to the measurement means 3, and a quadratic current I_{q} (sometimes noted I_{q} here) and direct current Id (sometimes noted I_{d}) return output connected to the return input of the current regulator 4.

The calculation unit 5 also comprises an estimated angular position input receiving the estimated value of the rotor angular position \hat{θ}_{elec} explained below, and a Park transformer calculator configured to transform the currents Iu, Iv, Iw measured according to the estimated value of the rotor angular position \hat{θ}_{elec} received as a component on the quadratic axis of the current vector referred to hereinafter as the quadratic current Iq, and the component on the direct axis of the direct current vector Id in a Park plane, also referred to hereinafter as the return direct current Id.

In the application, each reference in the following with “\hat{ }” is an estimated value.

The return direct current Id is therefore in the following the direct component of the stator current in the Park plane calculated from the stator currents measured.

The return quadratic current Iq is therefore hereinafter the quadratic component of the stator current in the Park plane calculated from the stator currents measured.

The current regulator 4 comprises summers 41 (represented by a single summer in FIG. 1), receiving as non-inverting input the setpoint quadratic current vector I^{#}_{q}′ and the setpoint direct current vector I^{#}_{d}′ modified and as inverting input the return quadratic current vector Iq as well as the return direct current vector Id.

At the output of the summers 41, the regulator 4 includes a line on which the difference between the quadratic setpoint current I^{#}_{q}′ and the return quadratic current Iq circulates, as well as the setpoint direct current I^{#}_{d}′ and the return direct current Id on another line. Both lines are represented by a single line. The current regulator 4 comprises a block of PI (proportional-integral) current regulators 42 connected to the difference lines and delivering the voltage setpoint V^{#}_{dq} comprising quadratic voltages and direct voltages.

The control device 2 comprises, in addition to the regulation loop R, a closed loop adaptive angle estimator 6, for estimating an estimated value of the rotor angular position \hat{θ}_{elec}, in particular from start-up of the electric machine (rotor rotation speed=0) to the predetermined threshold speed. The regulation loop R may comprise an angle estimator, not represented, according to the electromotive force which is then used beyond the predetermined speed.

In this example of this embodiment, the speed is the electrical speed (volts/s) but could be the rotor rotation speed. The predetermined threshold speed is, for example, the speed required for operation of the angle estimator according to the electromotive force. For example of the predetermined threshold speed is an electrical speed corresponding to a value of rotor rotation speed at 500 rpm. An electrical angle=mechanical angle of the rotor multiplied by the number of pole pairs.

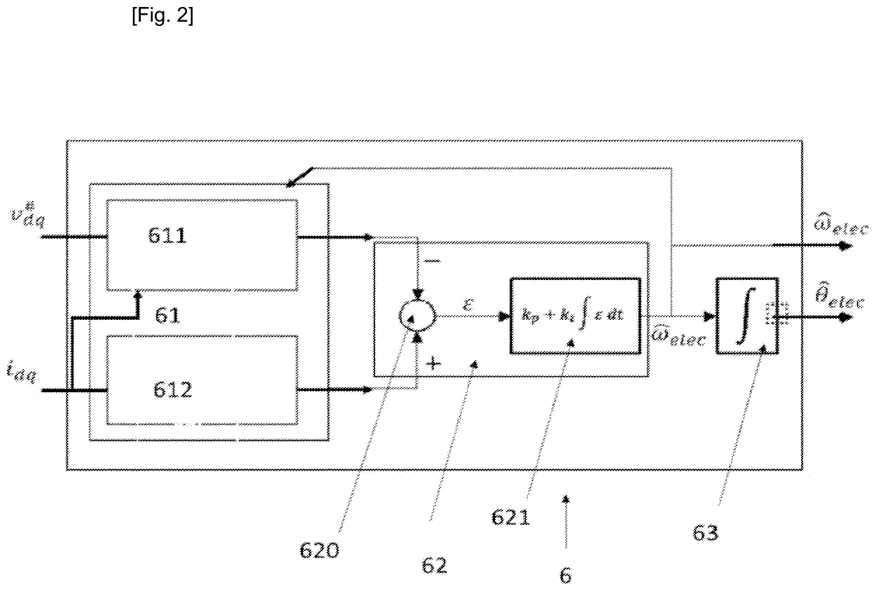

The closed loop adaptive angle estimator 6, represented in detail in FIG. 2, comprises a first stator flux calculator 61. The first stator flux calculator 61 comprises two calculation blocks for calculating a reference stator quadratic flux λq calculated from measured value and predetermined constant and an adaptive stator quadratic flux λqv different from the reference stator quadratic flux λq in that it is further dependent on the voltage setpoint V #dq calculated.

The first stator flux calculator 61 therefore comprises a first calculation block 611 for calculating the reference stator quadratic flux λq as a function of the return quadratic current I_{q}. In particular, in this example of this embodiment, the reference stator quadratic flux λq is calculated according to the formula: L_{q}I_{q} in which L_{q} is the stator inductance on the axis q. In this example, the stator inductance L_{q} is a predetermined value, here it is assumed that the variation in the inductances as a function of the current is negligible, i.e. the stator does not exhibit magnetic saturation (inductance which sharply falls when the stator current increases in amplitude). The inductances are considered as apparent inductances (i.e. almost constant for a given current point) or the link between the flux and the current remains linear via this inductance: L=flux/current→an increasing straight line.

The first stator flux calculator 61 therefore also comprises a second block 612 for calculating the adaptive quadratic stator flux λqv, which may also be called an adaptive flux observer, from the voltage setpoint V #dq, the return quadratic current I_{q}, the return direct current I_{d}, and the estimated electrical speed \hat{ω}_{elec} calculated.

In particular, in this example of this embodiment, the adaptive quadratic stator flux λqv is calculated by the integral of the following formula:

$${v}_{q} - {R}_{s} {i}_{q} - {\hat{ω}}_{elec} {\hat{λ}}_{{d}_{v}} + k {\tilde{i}}_{q} \qquad [ Math 8 ]$$

wherein Rₛ is the stator resistance, \hat{λ}_{d}_{ᵥ} is the adaptive direct stator flux equal to the integral of the following formula:

$${v}_{d} - {R}_{s} {i}_{d} - {\hat{ω}}_{elec} {\hat{λ}}_{{q}_{v}} + k {\tilde{i}}_{d} \qquad [ Math 9 ]$$

and in that K is a positive gain matrix.
\hat{ι}_{d} and \hat{ι}_{q} are the direct and quadratic components of the error in currents with

$${\tilde{i}}_{d} = {i}_{d} - {\hat{i}}_{d} \qquad [ Math 10 ]$$

$${\tilde{i}}_{q} = {i}_{q} - {\hat{i}}_{q}$$

and wherein the estimated direct current \hat{ι}_{d} and the quadratic estimated current \hat{ι}_{q} are calculated as a function of:

$${\hat{i}}_{d} = \frac{{\hat{λ}}_{{q}_{v}} - {φ}_{PM}}{{L}_{d}} \qquad [ Math 11 ]$$

$${\hat{i}}_{q} = \frac{{\hat{λ}}_{{q}_{v}}}{{L}_{q}}$$

The role of the first stator flux calculator 61 is to make it possible to obtain values of the reference quadratic flux λq which has as a variable return currents which is a function of measured current and an estimated angular position, and the adaptive quadratic stator flux λqv which also has as a variable the voltage setpoint V^{#}_{dq} and the calculated electrical speed in order to differentiate them to thus make it possible to identify a positioning estimation error.

The adaptive angle estimator 6 therefore comprises a second calculator 62 for an estimated electrical speed \hat{ω}_{elec} as a function of the comparison of the adaptive quadratic stator flux λq with the reference quadratic stator flux λq. The second calculator 62 therefore comprises a comparator 620 comprising, herein as a negative input, the reference quadratic stator flux λq and, as a positive input, the adaptive quadratic stator flux λq and, as an output, a comparison value ε representing the difference between both fluxes calculated. The second calculator 62 also includes a phase-locked loop (PLL) 621 for calculating an estimated value of electrical speed \hat{ω}_{elec} from the comparison value between the reference quadratic stator flux and the adaptive quadratic stator flux.

The adaptive angle estimator 6 further comprises a third calculator for calculating the electrical position of an estimated value of the rotor angular position \hat{ω}_{elec} from the estimated values of electrical speed \hat{θ}_{elec}. The estimated value of the rotor angular position \hat{θ}_{elec} is transmitted to the calculation unit 5. The estimated value of the rotor angular position \hat{θ}_{elec} is estimated at each instant t as a function of the integral of the estimated values of electrical speed \hat{ω}_{elec}.

The control device 2 further comprises a modifier 7 for a setpoint direct current I^{#}_{d} of a setpoint current I^{#}_{dq} received by an input. The modifier 7 thus allows from start-up to the predetermined threshold speed modification of the setpoint direct current I^{#}_{d} into a non-zero direct regulator setpoint current I^{#}_{d′} transmitted into the current regulator. In particular, modifier 7 comprises a comparator 70 for the absolute value of the estimated electrical speed \hat{ω}_{elec} received by the adaptive angle estimator 6 with the predetermined threshold speed. If the estimated electrical speed \hat{ω}_{elec} is less than the predetermined threshold speed, the modifier 7 comprises a calculation block 71 which calculates the regulator setpoint direct current I^{#}_{d′} with a non-zero value and transmits it to the current regulator 4. Herein, in this example, the calculation block 71 calculates the regulator setpoint direct current I^{#}_{d′} equal to the sign of the estimated electrical speed \hat{ω}_{elec} (to determine the direction of rotation of the rotor) multiplied by a maximum of two terms which are as follows:

The first term, denoted μi_{q}^{#} constitutes a proportion of the quadratic component of the current setpoint.

The second term is the square root of the difference between the squared value of the maximum amplitude of the stator currents that the voltage inverter can withstand (denoted Ipeak) and the squared value of the quadratic component of the current setpoint:

$$( \sqrt{{I}_{peak}^{2} - {i}_{q}^{\#2}} ) \qquad [ Math 12 ]$$

According to another example of, the regulator setpoint direct current I^{#}_{d′} is a predetermined direct current.

The setpoint current I^{#}_{dq} may originate from a control unit of the propulsion unit(s) transmitting the setpoint in setpoint direct current I^{#}_{d} and in quadratic setpoint current I^{#}_{q}, with an angle a to the modifier 7.

In this example, the modifier 7 also transmits the regulator quadratic setpoint current I^{#}_{q}′ which is equal to the quadratic setpoint current I^{#}_{q}, wherein the same can be directly transmitted to the current regulator 4.

In this embodiment, the control device is adapted to control the converter for a rotation speed beyond the predetermined threshold speed. The modifier 7 of setpoint current transmits the regulation setpoint current I^{#}_{dq′} according to the setpoint current I^{#}_{dq} only if the absolute value of the estimated electrical speed \hat{ω}_{elec} is greater than the predetermined threshold speed.

In this embodiment, the setpoint current I^{#}_{dq} comprises a setpoint direct current I^{#}_{d} equal to zero. According to another example, in the case where the setpoint direct current I^{#}_{d} is different from zero, for a rotation speed beyond the predetermined threshold speed, the modifier 7 of the setpoint current imposes the regulator setpoint direct current I^{#}_{d′} to zero except in the case of defluxing control.

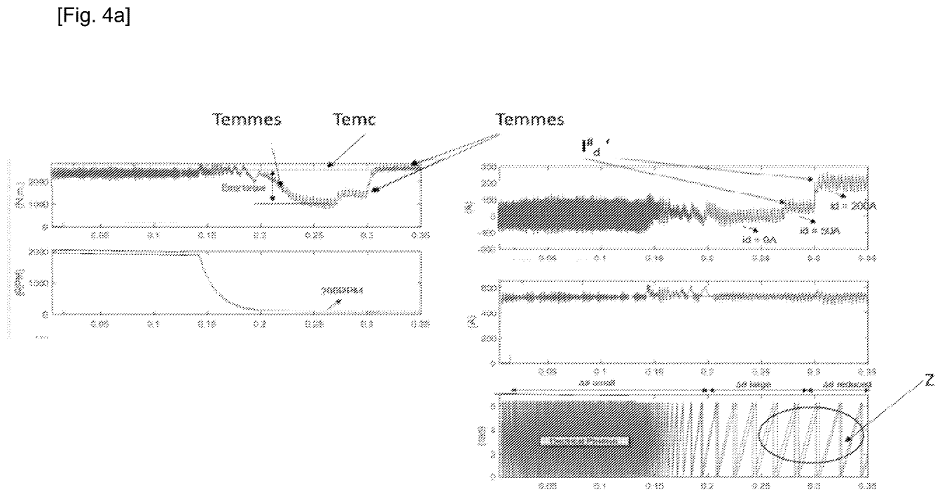

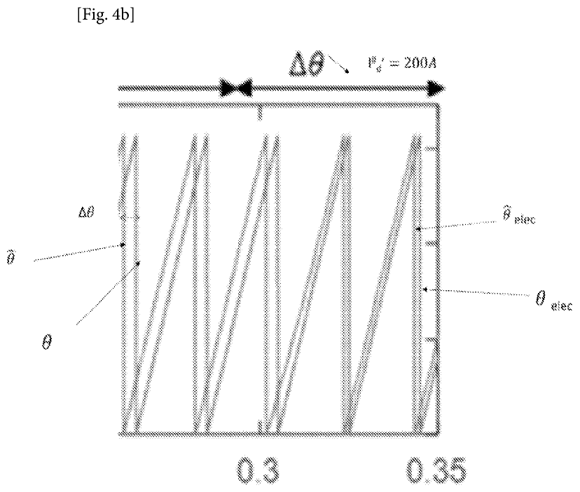

FIG. 4a represents various time graphs showing the performance of the control device according to the invention.

Column 1, row 2 represents the speed as a function of time wherein, the speed decreases from 0.15 (t) from 2000 rpm to 200 rpm stabilised from 0.2 to 0.35 (t), (t) being a time unit.

Column 1, row 1 represents a curve of the set torque Temc as a function of time and a curve of the measured torque Temmes, wherein the setpoint torque is 2500N·m between 0(t) and 0.3(t) and a curve of the measured torque Temc equal to K I_{q} which begins to deviate from the actual torque between 0.2(t) and 0.3(t) and then between 0.3(t). This deviation is linked to an angular position error in the control.

Column 2, row 1 represents the regulator setpoint direct current I^{#}_{d}′ wherein between 0.25(t) and 0.3 (t) the regulator setpoint direct current I^{#}_{dq}′=50 Amp and then from 0.3 (t) to 0.35 (t)=200 Amp is modified.

Column 2, row 2 represents the regulator quadratic setpoint current I^{#}_{q}′ which is regular around 550 Amperes.

Column 2, row 2 represents the actual rotor angular position θ relative to the rotor angular position \hat{θ} calculated (a function of the electrical angular position θ_{elec} and the number of poles in the rotor). FIG. 4b represents a magnification of this graph in zone Z, of the actual rotor angular position θ relative to calculated rotor angular position \hat{θ} between 0.25 (t) and 0.35 (t). In this figure, a significant difference in angular position Δθ at around 0.25 which slightly decreases at around 0.3 and then sharply decreases from 0.3 to 0.35 can be seen.

Thus, the fact that the direct current modifier 7 modifies the setpoint direct current I^{#}_{d}′ from 0 to 50 Amperes very slightly reduces the angular position error (angular position difference Δθ) but by significantly modifying the setpoint direct current I^{#}_{d}′ from 0 to 200 Amperes, the position error is significantly reduced. As explained previously, the actual torque Tₑₘ is equal to the sum of the estimated torque \hat{T}ₑₘ=Klq and Kₜ\hat{ι}_{d} sin(Δθ), but as sin(Δθ) tends towards 0 when there is no position error, the product Kₜ\hat{ι}_{d} sin(Δθ), tends towards zero and thus \hat{T}ₑₘ=Kₜ\hat{ι}_{q} without angular position error as is visible on row 1 column 1 from 0.3(t) to 0.35(t).

Thus, the control device of the invention makes it possible to estimate an angular position of a rotor of a synchronous motor coupled to a load with a torque which may be significant, from standstill (start-up) up to a predetermined threshold speed, for example of 1000 rpm. Beyond the predetermined threshold speed, the control device can calculate the rotor angular position and the rotation speed according to the flux by the adaptive angle estimator 6, but with a regulator setpoint direct current equal to zero or by another angular position estimator calculating the position according to the electromotive force as in prior art.

Unless otherwise specified, a same element appearing in different figures has a single reference.

1. A control device for controlling an inverter converter for starting a multiphase synchronous electric motor of an electric machine up to a predetermined threshold speed, the control device comprising:
a regulation loop, comprising:
a current regulator for delivering a voltage setpoint comprising a quadratic and direct voltage with an angle, from a regulation current setpoint,
a calculation unit for calculating a direct and indirect Park transformation, the calculation unit comprising a current return output in a Park reference frame, from measurement values of the phase currents received, transformed in a Park reference frame, into a return quadratic current and into a return direct current, taking account of a value of estimated rotor angular position received, characterised in that the control device further includes:
a closed loop adaptive angle estimator, for estimating the value of the estimated rotor angular position, based on a difference between at least one piece of data of a reference stator flux vector calculated as a function of the return currents, and a piece of data of the adaptive stator flux vector, calculated from the voltage setpoint, the return currents, and an estimated electrical speed calculated as a function of this difference, and
a modifier of the setpoint current, wherein, when an absolute value of the estimated electrical speed received by the adaptive angle estimator is less than the predetermined threshold speed, the modifier calculates a regulator setpoint direct current having a non-zero value, thus modifying a setpoint direct current of a setpoint current received.

2. The control device for controlling an inverter converter for starting an electric motor according to claim 2, wherein the adaptive angle estimator comprises:
a first stator flux calculator comprising:
1. a first block for calculating the reference stator quadratic flux,
2. a second block for calculating the adaptive quadratic stator flux,
a second calculator for an estimated electrical speed as a function of a comparison between the adaptive quadratic stator flux and the reference quadratic stator flux,
a third calculator for estimating a value for the estimated rotor angular position as a function of the estimated electrical speed calculated.

3. The control device for controlling an inverter converter for starting an electric motor according to claim 2, the first calculation block calculates the reference quadratic flux according to the formula: L_{q}l_{q} wherein L_{q} is the stator inductance on the axis q.

4. The control device for controlling an inverter converter for starting an electric motor according to claim 2, wherein the second calculation block calculates the adaptive quadratic stator flux according to the integral of the following formula: v_{q}−Rₛ\dot{ι}_{q}−\hat{ω}_{elec}\hat{λ}_{d}_{ᵥ}+k\tilde{ι}_{q} wherein Rₛ is the stator resistance, λ_{d}_{ᵥ} is the adaptive direct stator flux equal to the integral of the following formula: v_{d}−Rₛ\dot{ι}_{d}+\hat{ω}_{elec}\hat{λ}_{q}_{ᵥ}+k\tilde{ι}_{d} and K is a positive gain matrix, \tilde{l}_{d} and \tilde{l}_{q} are the direct and quadratic components of the error in currents with:
$${\tilde{i}}_{d} = {i}_{d} - {\hat{i}}_{d}$$
$${\tilde{i}}_{q} = {i}_{q} - {\hat{i}}_{q}$$
and wherein the estimated direct current \tilde{l}_{d} and the estimated quadratic current \tilde{l}_{q} are calculated as a function of:
$${\hat{i}}_{d} = \frac{{\hat{λ}}_{{q}_{v}} - {φ}_{PM}}{{L}_{d}}$$
$${\hat{i}}_{q} = \frac{{\hat{λ}}_{{q}_{v}}}{{L}_{q}} .$$

5. The control device for controlling an inverter converter for starting an electric motor according to claim 1, wherein the modifier of the setpoint direct current calculates a regulator setpoint direct current equal to the square root of the sum of a value of the squared maximum quadratic current with the value of the setpoint quadratic current, received in the setpoint current:
$${I}_{{d}^{′}}^{\#} = \sqrt{Iq {max}^{2} - {I}_{q}^{\#2}} .$$

6. The control device for controlling an inverter converter for starting an electric motor according to claim 5, wherein calculating the modified setpoint direct current is imposed with the same sign as the estimated electrical speed received.

7. The control device for controlling an inverter converter for starting an electric motor according to claim 1, wherein the modifier of the setpoint direct current comprises a comparator for comparing the absolute value of the estimated electrical speed with the predetermined threshold speed.

8. The control device for controlling an inverter converter for starting an electric motor according to claim 1, wherein the control device is able to control the converter for a rotation speed beyond the predetermined threshold speed, wherein if the absolute value of the estimated electrical speed is greater than the predetermined threshold speed, the setpoint direct current modifier transmits the regulation setpoint current according to only the setpoint current.

9. The control device according to claim 8, wherein when the absolute value of the estimated electrical speed is greater than the predetermined threshold speed, the modifier of the setpoint direct current transmits the setpoint current with a setpoint direct current equal to zero, unless a defluxing setpoint is sent.

10. The control device according to claim 8, wherein, if the absolute value of the estimated electrical speed is greater than the predetermined threshold speed, the angular position estimator estimates the position and angular speed from an electromotive force EMF measured.

11. A synchronous electric machine comprising:
an electric motor comprising a rotor and a stator,
a current measurement sensor,
an inverter converter comprising power switches and
the control device according to claim 1,
wherein the calculation unit transmits a command to the converter from the voltage setpoint to drive the electronic power switches to a specific chopping frequency and thus drive the fundamental frequency of the stator voltage input to the electric machine for driving the electric motor.

12. A method for driving a synchronous machine in a closed loop without a position sensor, from start-up to maximum rotation speed, comprising:
modifying a received current setpoint by imposing a non-zero modified setpoint direct current as long as an estimated speed is less than a predetermined threshold speed value,
calculating a voltage setpoint comprising a quadratic and direct voltage with an angle, from a regulation current setpoint comprising a modified setpoint direct current,
calculating a command for driving the electronic power switches of the inverter converter at a specific chopping frequency and thus driving the fundamental frequency of the stator voltage input to the electric machine, by an inverse Park transformation of the voltage setpoint and of a rotor estimated angular position,
measuring the phase currents and transforming the phase currents in a Park reference frame, into a return quadratic current and a return direct current, taking account of the estimated rotor angular position,
calculating a reference stator quadratic flux as a function of the return quadratic current, the return direct current, the current return output and a calculated electrical frequency,
calculating adaptive quadratic stator flux, from the voltage setpoint, the return quadratic current, the return direct current, and the estimated electrical speed calculated,
calculating an electrical speed of the rotor from a comparison of the adaptive quadratic stator flux with the reference quadratic stator flux, and
calculating the value of the estimated rotor angular position as a function of the estimated electrical speed calculated.
